(19) United States
(12) Patent Application Publication
(10) Pub. No.: US 2023/0016602 A1
(43) Pub. Date: Jan. 19, 2023

(54) UPDATING CLUSTER DATA AT NETWORK DEVICES OF A CLUSTER

(71) Applicant: HEWLETT PACKARD ENTERPRISE DEVELOPMENT LP, Houston, TX (US)

(72) Inventors: Shravan Kumar Vuggrala, Bangalore (IN); Raghunandan Prabhakar, Bangalore (IN); Hao Lu, Fremont, CA (US)

(21) Appl. No.: 17/374,368

(22) Filed: Jul. 13, 2021

(51) Int. Cl. H04L 29/08; H04L 9/32

(52) U.S. Cl. CPC H04L 67/2895; H04L 67/1029; H04L 9/3247

(57) ABSTRACT

Examples relate to maintaining consistent cluster data across a cluster in a network. A computing system may receive a first signature of a first state of the cluster data present at a leader gateway and a plurality of signatures of a plurality of states of the cluster data present at a plurality of member network devices of the cluster. The cluster may include a plurality of gateways including the leader gateway and a plurality of member gateways. The member network devices may include the plurality of member gateways and a plurality of interconnecting network devices. In response to determining that a signature of the plurality of signatures received from one of the member network devices is different from the first signature, the computing system may send a message to one of the plurality of gateways to update the cluster data at the member network device to represent the first state.

### BACKGROUND

The high demand of data access has brought along an increased need to rapidly and conveniently deploy wired and/or wireless networks including Local Area Networks (LAN), Wireless Local Area Networks (WLAN), Wide-Area Networks (WAN), Enterprise, SD (Software-Defined)-WAN, SD-Branch, or Retail networks. A network may include several network devices such as interconnecting network devices (e.g., access points) and gateway devices (e.g., controllers).

### BRIEF DESCRIPTION OF THE DRAWINGS

For a more complete understanding of the present disclosure, examples in accordance with the various features described herein may be more readily understood with reference to the following detailed description taken in conjunction with the accompanying drawings, in which:

FIG. 1 is a block diagram depicting a computing environment for maintaining consistent cluster data across a cluster in a network, in accordance with one example;

FIG. 2 is a flow diagram of a method for maintaining consistent cluster data across a cluster in a network, in accordance with one example;

FIG. 3 is a flow diagram illustrating a method for maintaining consistent cluster data across a cluster in a network, in accordance with another example;

FIG. 4 is a flow diagram illustrating a method for maintaining consistent cluster data across a cluster in a network, in accordance with yet another example;

FIG. 5 is a flow diagram illustrating a method for maintaining consistent cluster data across a cluster in a network, in accordance with yet another example; and

FIG. 6 is a block diagram of a system including a processor and a computer-readable storage medium encoded with instructions to maintain consistent cluster data across a cluster in a network, in accordance with one example.

Certain examples have features that are in addition to or in lieu of the features illustrated in the above-referenced figures.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two as or more than two. The term “another,” as used herein, is defined as at least a second or more. The term “coupled,” as used herein, is defined as connected or coupled, whether directly without any intervening elements or indirectly with at least one intervening element, unless otherwise indicated. Two elements can be coupled mechanically, electrically, or communicatively linked through a communication channel, pathway, network, or system. It will also be understood that, although the terms first, second, third, etc. may be used herein to describe various elements, these elements should not be limited by these terms, as these terms are only used to distinguish one element from another unless stated otherwise or the context indicates otherwise.

When a network is initially deployed at a site such as an office, hospital, airport, and the like, potentially hundreds or thousands of network devices such as gateway devices (e.g., controllers) and interconnecting network devices (e.g., access points (APs), switches and the like) are configured before the network is operational. These network devices are configured, for example, to apply network identifiers, security settings, and other parameters that may be desired for the deployment. As used herein, a “gateway device” or “gateway” refers to a network device that provides a network with connectivity to a host network that is remote from the host network. For example, the gateway provides connectivity using Internet Protocol Security (IPSec) tunnel, Generic Routing Encapsulation (GRE), or the like. As used herein, an “interconnecting network device” refers to a device in a network that provides connectivity to the network infrastructure for transmitting and receiving packets from a client device (e.g., laptop, desktop computers, tablets, phones, servers, Internet of Things devices, sensors, etc.).

The initial deployment of the network may also include creating one or more clusters of the gateway devices at the site and mapping the interconnecting network devices such as access points and switches to the gateway devices for tunneling data from the interconnecting network devices to particular gateway devices. The cluster(s) of gateway devices may be implemented for a number of reasons, such as seamless failover, shared load, etc. When clustered, the gateway devices of a given cluster share responsibilities as distributed by a certain gateway device (referred to herein as “leader gateway”). The leader gateway may assign responsibilities to all of the other gateway devices (referred to herein as member gateways) of the given cluster, including itself. The interconnecting network devices mapped to the gateway devices of the given cluster may belong to the given cluster. Such deployment may use consistent data (referred to herein as ‘cluster data’) related to the configuration of the given cluster such as a bucket map, node list, Pairwise Master Key (PMK) cache, and the like across the given cluster to maintain uninterrupted packet flow for smooth and continuous operation at the network. The data consistency across the given cluster may mean that the network devices (e.g., the gateway devices and the interconnecting network devices) of the given cluster have consistent cluster data.

In order to ensure consistency of the cluster data across the given cluster, the cluster data may be provided to each member gateway and interconnecting network device (collectively referred to herein as ‘member network devices’ or simply ‘member devices’) of the given cluster by sending a message including a state (e.g., snapshot) of the cluster data. For example, the leader gateway may send messages including the state of the cluster data to the member gateways of the given cluster and each member gateway may send messages including the state of the cluster data to the interconnecting network devices mapped to the member gateway. However, the data consistency across the given cluster may be impacted due to an anomaly such as weak signal strength (e.g., Wi-Fi signal), traffic congestion, hardware errors on a particular network device, etc. For example, a message including the state of the cluster data may be dropped due to network congestion or errors in the data transmission. In situations where the state of the cluster data is not consistent across the given cluster, the member devices in the cluster may interpret the cluster data differently which may affect the operation and overall performance at the network site. For example, an access point that uses a given cluster data (e.g., bucket map) that is different from a bucket map used by the leader gateway and the member gateways in a cluster may direct the packets to a member gateway that is not mapped to the given access point. This results in dropping of the packets at the site.

Examples disclosed herein address the technical issues discussed above by maintaining consistent cluster data across a cluster in a network. Maintaining the cluster data across the cluster may mean maintaining the latest version of the cluster data across a plurality of member devices of the cluster. In particular, the described examples are directed to identifying a member network device that does not have the latest version of the cluster data (referred to herein as an “inconsistent member device”) and automatically updating the cluster data at the inconsistent member device. The described examples, therefore, ensure consistent cluster data across the cluster, which helps in avoiding dropping of packets and enable smooth and uninterrupted packet flow for continuous operation at the network.

A member network device may refer to a network device associated to the cluster of the network and is separate from a leader gateway. In an example, the member network device may include a member gateway or an interconnecting network device (e.g., an AP).

In some examples, a computing system may receive a first signature of a first state of the cluster data present at a leader gateway of a cluster and a plurality of signatures of a plurality of states of the cluster data present at a plurality of member network devices of the cluster. The cluster may include a plurality of gateways including the leader gateway and a plurality of member gateways. The plurality of member network devices of the cluster may include the plurality of member gateways and a plurality of interconnecting network devices associated with the cluster. The computing system may determine whether any signature of the plurality of signatures is different from the first signature. In response to determining that a signature of the plurality of signatures received from one of the plurality of member network devices is different from the first signature, the computing system may send a message to a gateway of the plurality of gateways to update the cluster data at the member network device to represent the first state.

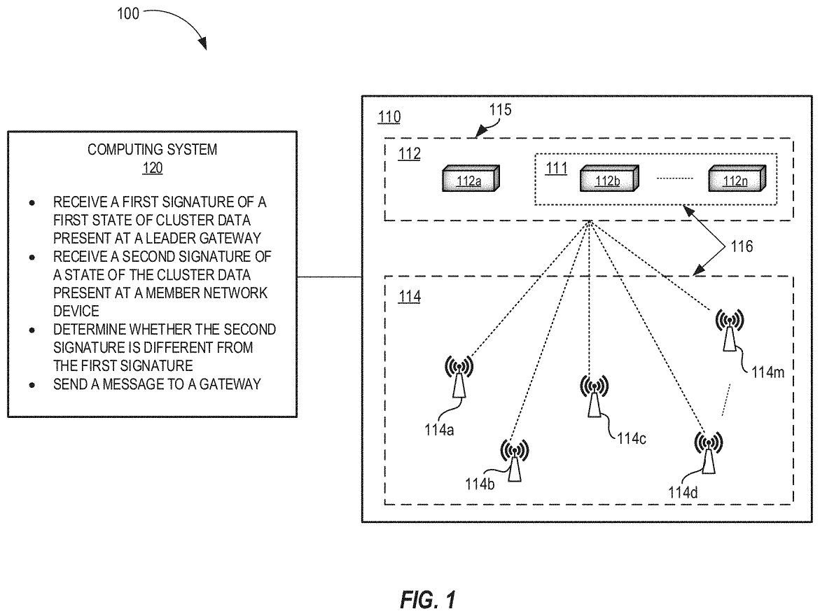

FIG. 1 illustrates an example computing environment 100 including a network 110 and a computing system 120. The computing system 120 may be remote from the network 110. In some examples, the network 110 may represent a virtual local area network (VLAN). The computing system 120 may be communicatively coupled to the network 110 via a computer network. The computer network may be a wireless or wired network. The computer network may include, for example, a Wide Area Network (WAN), a Metropolitan Area Network (MAN), a Storage Area Network (SAN), a Campus Area Network (CAN), or the like. Further, the computer network may be a public network (for example, the Internet) or a private network.

In some examples, the network 110 may be present at a site. As used herein, the term “site” refers to a pre-defined physical space in a geographical area. Some examples of a “site” may include a building, a campus (e.g., office, hospital, institution, and the like), etc. The network 110 may include a plurality of gateways 112a, 112b, . . . 112n (collectively referred to as “gateways 112”) and a plurality of interconnecting network devices 114a, 114b, . . . 114m (collectively referred to as “interconnecting network devices 114”). Although FIG. 1 shows APs 114 for purposes of simplicity, at least some of the APs 114 may be replaced by switches or other interconnecting network devices. Any number of gateways 112 and interconnecting network devices 114 may be implemented in the network 110. In some examples, at least two gateways may be implemented in the network 110 for redundancy. Accordingly, in some examples, in situations where one gateway fails, one or more of the other gateways may process packet flow in place of the failed gateway. In addition, in situations where one gateway is undergoing maintenance or an upgrade, the data traffic may be tunneled to the other gateway or gateways to avoid a slowdown.

The computing system 120 may include a cloud computing system. As used herein, the term “cloud computing system” (or “cloud”) refers to on-demand network access to a shared pool of information technology resources (e.g., networks, servers, storage, and/or applications) that can be quickly provisioned. The cloud computing system may include a public cloud system, a private cloud system, or a hybrid cloud system. The cloud computing system may be used to provide or deploy various types of cloud services. These may include Infrastructure as a Service (IaaS), Platform as a Service (PaaS), Software as a Service (SaaS), and so forth.

In some examples, the computing system 120 may include a processing resource (not shown). Examples of the processing resource may include a computing device, a server, a desktop computer, a smartphone, a laptop, a network device, dedicated hardware, a virtualized device, or the like. The processing resource may include a processor and a machine-readable storage medium communicatively coupled to the processor. The machine-readable storage medium may store machine-readable instructions that, when executed by the processor, may cause the computing system 120 to undertake certain actions and functionalities as described herein.

In some examples, the computing system 120 may further include a database (not shown) that stores data, such as log data, acquired by the computing system 120. The data may include configurations of the network 110 including a network address, information related to the gateways 112 and the interconnecting network devices 114 belonging to the network 110, and the like.

In some examples, the computing system 120 may enable the deployment of the network 110 via configuring the gateways 112 and the interconnecting network devices 114. In certain examples, the computing system 120 may enable the deployment of the network 110 with no or minimal manual intervention. Although the examples described herein include a description related to the deployment of a single network, such as the network 110 of FIG. 1, the computing system 120 may perform the deployment of multiple networks at one or more sites.

In certain examples, each of the gateways 112 and the interconnecting network devices 114 may be communicatively connected to the computing system 120 via a secure channel to ensure protection from malicious attacks and data breaches. The secure channel may include web socket or IPsec tunnel.

During the deployment of the network 110, the computing system 120 may create a cluster 115 of the gateways 112 that may belong to the network 110 and assign the interconnecting network devices 114 to the cluster 115 for tunneling packets from the interconnecting network devices 114 to the gateways 112. In some examples, more than one cluster of gateways may be created depending on a number of gateways and a number of interconnecting network devices, the size of the network site, and/or location of the interconnecting network devices and the gateways. When the cluster 115 is initialized, one of the gateways 112 (e.g., the gateway 112a) may be nominated as a leader (also referred to as “leader gateway 112a”). The rest of the gateways, for example, the gateways 112b, . . . 112n, of the cluster 115 may be referred to as member gateways (also, collectively referred to as “member gateways 111”).

In some examples, the leader gateway 112a may perform several functions including, but not limited to, mapping a given interconnecting network device 114 to a particular member gateway 111, updating cluster data across the cluster 115, distributing a load across the interconnecting network devices 114 mapped to the cluster 115, etc. The mapping may refer to creating communication channels for each interconnecting network device 114 to a particular member gateway 111 for tunneling packets from the interconnecting network devices 114 to the respective member gateways 111. The packets from a given interconnecting network device 114 may be tunneled to the member gateway 111 mapped to the given interconnecting network device 114 based on the criteria including, but not limited to, a load of each interconnecting network device 114 and each member gateway 111.

The cluster data may refer to data related to the configuration of the cluster 115 that is maintained consistently across the network devices in the cluster 115 to avoid dropping packets and ensure the continuous transmission of packets for the functioning of the network 110. In order to maintain consistent cluster data across the cluster 115, the cluster data may be maintained consistently on the interconnecting network devices 114 and/or the gateways 112. In some examples, the cluster data may be provided to all the interconnecting network devices 114 and the gateways 112 of the cluster 115. Examples of such cluster data that is maintained consistently among all the interconnecting network devices 114 and the gateways 112 may include a node list and a bucket map. The node list may represent a list of the member gateways 111 to which the interconnecting network devices 114 are mapped. The bucket map may include information to direct packets to a particular member gateway 111 based on clients' media access control (MAC) addresses. In some examples, the cluster data may be provided or updated to all the gateways 112 of the cluster 115. Examples of such cluster data that is maintained consistently among all the gateways 112 may include VLAN configuration, policies and/or access control rules, session information, PMK cache, identification information (e.g., Internet Protocol (IP) address and/or MAC address) of clients, etc.

The cluster configuration may be changed during the operation of the network 110 (e.g., the interconnecting network device 114b is changed from being mapped to the gateway 112b to the gateway 112n). Accordingly, the cluster data may be updated to reflect the changes in the cluster configuration. In an example, the leader gateway 112a may update the cluster data as per the changes in the cluster configuration. Further, the latest version of the cluster data may be updated across the cluster 115 to maintain consistent cluster data across the cluster 115. Updating the cluster data across the cluster 115 may mean providing, by the leader gateway 112a, a state of the latest version of the cluster data (referred to herein as a first state of the cluster data) to the member gateways 111 and/or the interconnecting network devices 114 of the cluster 115. As used herein, the term “state” may refer to a snapshot of a version of the cluster data. In some examples, the leader gateway 112a may send the first state of the cluster data (i.e., a snapshot of the latest version of the cluster data) to all the member gateways 111. In examples where the cluster data is to be updated to all the interconnecting network devices 114 of the cluster 115, each member gateway 111 may send the first state of the cluster data to the interconnecting network devices 114 mapped to that member gateway 111.

In situations where the cluster data is updated across the cluster 115, the leader gateway 112a may provide the first state of the cluster data to the member gateways 111 and/or the interconnecting network devices 114 (collectively referred to herein as ‘member device 116’) of the cluster 115. In some examples, the leader gateway 112a may send a signature of the first state of the cluster data (referred to herein as ‘first signature’) to the computing system 120 while or after sending the first state to all the member gateways 111. As used herein, the term “signature” may refer to an identifier of a state (e.g., snapshot) of cluster data, that is unique for the state. In some examples, the signature may be a cryptographic hash created, using a cryptographic hash function, for the data content of the state of the cluster data. In this manner, a signature may uniquely represent a certain state of the cluster data. For example, a signature created for the first state of the cluster data may uniquely represent the first state of the cluster data.

In some examples, the computing system 120 may receive the first signature from the leader gateway 112a. The computing system 120 may also receive identification information (e.g., IP address, MAC address, or both) of the leader gateway 112a along with the first signature. The identification information of the leader gateways 112a may help the computing system 120 to identify that the first signature is received from the leader gateway 112a.

In situations where a given member device 116 (e.g., the interconnecting network device 114b) receives the first state of the cluster data, the given member device 116 may send a signature of the first state of the cluster data to the computing system 120. In some examples, the given member device 116 sends the signature of the first state of the cluster data to the computing system 120 immediately after receiving the first state.

In some examples, the computing system 120 may receive the signature of the first state of the cluster data from the given member device 116. The computing system 120 may also receive identification information (e.g., IP address, MAC, or both) of the given member device 116 along with the signature. The identification information of the given member device 116 may help the computing system 120 to identify that the signature is received from the given member device 116.

In some situations where the given member device 116 does not receive the first state of the cluster data (for example, due to dropping of a message), the computing system 120 may not receive the signature of the first state of the cluster data from the given member device 116. In some of these situations, although the computing system 120 may not receive the signature of the first state of the cluster data, the computing system 120 may have received, previously, another signature of another state (e.g., the previous state of a previous version of the cluster data) of the cluster data from the given member device 116.

In this manner, the computing system 120 may have the first signature, received from the leader gateway 112a, of the first state of the cluster data present at the leader gateway 112a and a signature (referred to herein as a second signature) of a state of the cluster data received from the given member device 116. In some examples, the second signature represents the latest state of the cluster data that is present at the given member device 116.

In the examples as described herein, the computing system 120 may perform the functionalities to maintain consistent cluster data across the cluster 115. In particular, the computing system 120 may perform the functionalities to identify whether the given member device 116 is an inconsistent member device. In response to receiving the first signature from the leader gateway 112a (identified by the identification information of the leader gateway 112a), the computing system 120 may determine whether the second signature received from the given member device 116 represents the first state of the cluster data. The computing system 120 may wait for a predetermined time period after receiving the first signature for determining whether the second signature received from the given member device 116 represents the first state of the cluster data. The predetermined time period may be defined, by an administrator, based on time taken (including retries) for the first state to be received by the given member device 116 from a gateway of the plurality of gateways 112 and any delay (including retries) for the signature to be received by the computing system 120 from the given member network device 116.

In some examples, the computing system 120 may identify, from the database of the computing system 120, a signature (i.e., the second signature) received from the given member device 116 (identified by the identification information of the given member device 116). As alluded, the second signature may be a signature of the latest state of the cluster data that is present at the given member device 116. The latest state of the cluster data at the given member device 116 may be the same or different from the first state of the cluster data depending on whether the given member device 116 receives the first state or not. In some situations where the given member device 116 receives the first state of the cluster data, the latest state of the cluster data at the given member device 116 may be the same as the first state, and in such situations, the second signature may be same as the first signature. In other situations where the given member device 116 does not receive the first state of the cluster data, the latest state of the cluster data that is present at the given member device 116 may be different from the first state, and in such situations, the second signature may be different from the first signatures.

In order to determine whether the second signature received from the given member device 116 represents the first state of the cluster data, the computing system 120 may determine whether the second signature is different from the first signature. In some examples, the computing system 120 may compare the second signature with the first signature. In some instances where the second signature is the same as the first signature, it may be determined that the latest state of the cluster data present at the given member device 116 is the same as the first state. In these instances, the computing system 120 may determine that the given member device 116 has received the first state of the cluster data and is consistent with the leader gateway 112a. In other instances where the second signature is different from the first signature, it may be determined that the latest state of the cluster data present at the given member device 116 is different from the first state. In these instances, the computing system 120 may determine that the given member device 116 has not received the first state of the cluster data and is inconsistent with the leader gateway 112a. In these instances, the computing system 120 may identify that the given member device 116 is an inconsistent member device.

In response to determining that the given member device 116 is the inconsistent member device, the computing system 120 may send a message to one of the plurality of gateways 112 to update the cluster data at the identified inconsistent member device 116 to represent the first state. In some examples, updating the cluster data may include providing the first state of the cluster data to the identified inconsistent member device 116.

In some situations where the identified inconsistent member device 116 is a member gateway (e.g., the member gateway 112b), the computing system 120 may send the message to the leader gateway 112a to update the cluster data at the inconsistent member gateway 112b to represent the first state. In response to receiving the message, the leader gateway 112a may send the first state of the cluster data to the inconsistent member gateway 112b to update the inconsistent member gateway 112b to be consistent with the leader gateway 112a. In some situations where the inconsistent member device 116 is an interconnecting network device 114 (e.g., the interconnecting network device 114b), the computing system 120 may send a message to a member gateway 111 mapped to the inconsistent interconnecting network device 114b to update the cluster data at the inconsistent interconnecting network device 114b to represent the first state. In response to receiving the message, the member gateway 111 may send the first state of the cluster data to the inconsistent interconnecting network device 114b to update the inconsistent interconnecting network device 114b to be consistent with the leader gateway 112a.

In some situations where a new member network device (e.g., an interconnecting network device) joins the network 110, the computing system 120 may configure the new member network device and map it to the cluster 115. In these instances, the new member network device does not have any information about the configuration of the cluster 115 for tunneling the packet flow. The leader gateway 112a may map the new member network device to one of the member gateways 111 and provide the first state of the cluster data (i.e., a state of the latest version of the cluster data) to the new member network device. In response to receiving the first state of the cluster data, the new member network device may send a signature (e.g., a third signature) of the first state of the cluster data present on the new member network device. In some instances where the new member network device does not receive the first state of the cluster data, the new member network device may not send the third signature to the computing system 120.

In order to determine whether the first state of the cluster data is received at the new member network device, the computing system 120 may determine whether the third signature from the new member network device (identified by its identification information) is received. The computing system 120 may wait for a predetermined time period (described previously) after receiving the first signature for determining whether the third signature from the new member network device is received. In some situations where the computing system 120 determines that the third signature from the new member network device is received, the computing system 120 may perform a check that the third signature is the same as the first signature to ensure that the new member network device has received the first state of the cluster data. In some situations where the computing system 120 determines that no signature is received from the new member network device, the computing system 120 may determine that the new member network device is an inconsistent member device. The computing system 120 may then send a message one of the gateways 112 to update the cluster data at the new member network device to represent the first state. For example, in situations where the new member network device is a gateway device, the computing system 120 may send the message to the leader gateway 112a or in situations where the new member network device is an interconnecting network device, the computing system 120 may send the message to a member gateway 111 mapped to the new interconnecting network device. In response to receiving the message, the leader gateway 112a or the member gateway 111 may send the first state of the cluster data to the new member network device to update the new member network device to be consistent with the leader gateway 112a.

In some examples, the computing system 120 may receive a plurality of signatures of a plurality of states of the cluster data present at the member devices 116. In certain examples, the computing system 120 may receive, from each of the member devices 116, a signature of a state of the cluster data present at the member devices 116. For example, in situations where there are five member devices 116 in the cluster 115, the computing system 120 receives five signatures for the five member devices 116. In these examples, the computing system 120 may determine whether each signature of the plurality of signatures received from the respective member devices 116 represents the first state of the cluster data. The computing system 120 may wait for a predetermined time period (described previously) after receiving the first signature for determining whether each of the plurality of signatures represents the first state of the cluster data. The computing system 120 may perform the same functionalities as described above to determine whether any member device 116 has not received the first state of the cluster data. In an example, the computing system 120 may compare each signature of the plurality of signatures with the first signature. In some situations where a signature of the plurality of signatures received from a given member device 116 (e.g., the interconnecting network device 114b) is different from the first signature, the computing system 120 may identify that the given member device 116 has not received the first state of the cluster data, and is an inconsistent member device. In response to identifying the given member device 116 as the inconsistent member device, the computing system 120 may send a message to update the cluster data at the inconsistent member device 116 to one of the gateways 112, as described previously.

In some examples, the computing system 120 may identify more than one inconsistent member device (e.g., the interconnecting network device 114b and the member gateway 112b). In these instances, the computing system 120 may send a message to the member gateway 111 mapped to the inconsistent interconnecting network device 114b to update the cluster data at the inconsistent interconnecting network device 114b and another message to the leader gateway 112a to update the cluster data at the inconsistent member gateway 112b to represent the first state. In response to receiving the messages, the leader gateway 112a and the member gateway 111 may send the first state of the cluster data, respectively, to the inconsistent member gateway 112b and the inconsistent interconnecting network device 114b to update them to be consistent with the leader gateway 112a.

In some situations where the network is deployed and the cluster 115 is formed, the leader gateway 112a configures the member devices 116. In these situations, the member devices 116 do not have any information of the cluster data. The leader gateway 112a may provide the latest version of the cluster data across the cluster 115. In these situations, it is the first occurrence for the member devices 116 to receive a state (i.e., the first state) of the cluster data. In some situations where a given member device 116 does not receive the first state of the cluster data, the computing system 120 may not receive a signature from that given member device 116. In such situations, in response to receiving the first signature from the leader gateway 112a, the computing system 120 may determine whether it has received a signature from each member device 116. The computing system 120 may wait for a predetermined time period (described previously) after receiving the first signature for determining whether a signature from each member device 116 is received.

The computing system 120 may have information about all the member devices 116 of the cluster 115 such as a number of member devices of the cluster 115 and their identification information. In some examples, the computing system 120 may compare the number of member devices of the cluster 115 and a number of signatures of the plurality of signatures received from the member devices 116. In situations where the number of member devices 116 of the cluster 115 and the number of received signatures are different, the computing system 120 may determine that a signature is not received from one or more member devices 116. In response to determining that the signature is not received from the one or more member devices 116, the computing system 120 may determine that the member device(s) 116 (identified by their respective identification information) have not received the first state of the cluster data, and identify them as inconsistent member device(s). After identifying the inconsistent member device(s), the computing system 120 may send a message, to update the cluster data at the identified inconsistent member device(s) 116, to one of the gateways 112. For example, in situations where it is determined that interconnecting network device 114b and the member gateway 112b are inconsistent member devices, the computing system 120 may send a message to the member gateway 111 mapped to the inconsistent interconnecting network device 114b and another message to the leader gateway 112a to update the cluster data at the inconsistent member gateway 112b to represent the first state. In response to receiving the messages, the leader gateway 112a and the member gateway 111 may send the first state of the cluster data, respectively, to the inconsistent member gateway 112b and the inconsistent interconnecting network device 114b to update them to be consistent with the leader gateway 112a.

The examples described herein identify any inconsistent member device 116 in the cluster 115 and update the cluster data at the inconsistent member device 116 to represent the first state and to be consistent with the leader gateway 112a. When each member device 116 is consistent with the leader gateway 112a, all the member devices 116 of the cluster 115 are consistent with one another. In this manner, the examples enable maintaining consistent cluster data on each member device 116 to ensure consistency across the cluster 115, which results in improving uninterrupted packet flow and hence, the overall operation of the network 110.

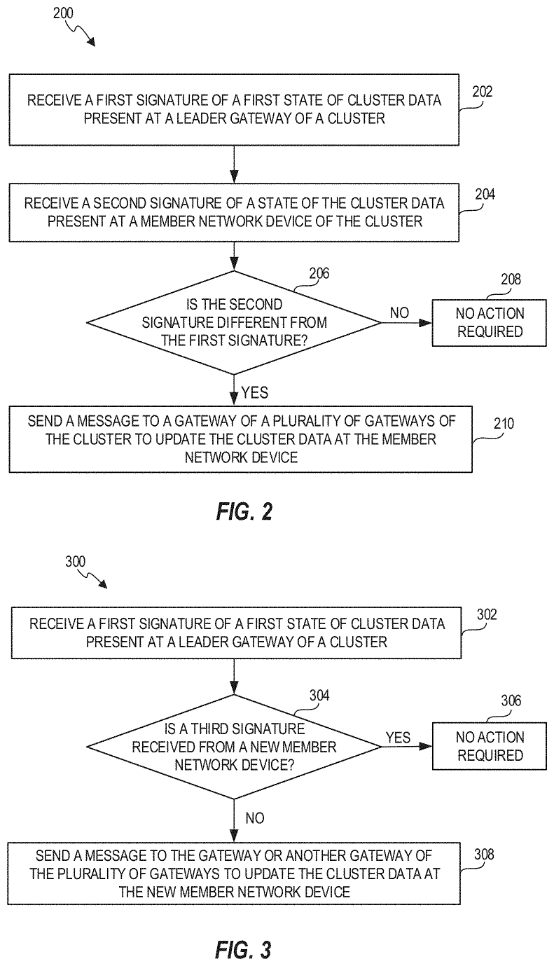

FIGS. 2-5 are flow diagrams depicting example methods 200, 300, 400, and 500 for maintaining consistent cluster data across a cluster in a network (e.g., the cluster 115 of the network 110 of FIG. 1). The example methods 200, 300, 400, and 500 may, for example, be executed by a service provided from a computing system (e.g., the computing system 120 of FIG. 1). For illustration purposes, the execution of example methods 200, 300, 400, and 500 is described in conjunction with the computing system 120 of FIG. 1. Although the below description is described with reference to the computing system 120 of FIG. 1, other applications or devices suitable for the execution of the example methods 200, 300, 400, and 500 may be utilized. Additionally, implementation of the example methods 200, 300, 400, and 500 is not limited to such examples. Although the flow diagrams of FIGS. 2-5 show a specific order of performance of certain functionalities, the example methods 200, 300, 400, and 500 are not limited to such order. For example, the functionalities shown in succession in the flow diagrams may be performed in a different order, may be executed concurrently or with partial concurrence, or a combination thereof.

Referring to FIG. 2, a flow diagram depicting an example method 200 for maintaining consistent cluster data across the cluster 115 is presented, in accordance with an example. At block 202, the computing system 120 may receive a first signature of the first state of the cluster data present at the leader gateway 112a of the cluster 115. The first state may represent the latest version of the cluster data. In an example, the computing system 120 may receive the first signature from the leader gateway 112a.

At block 204, the computing system 120 may receive a second signature of a state of the cluster data present at a member device 116 (e.g., the interconnecting network device 114b) of the cluster 115. The state of the cluster data at the interconnecting network device 114b may be the same or different from the first state of the cluster data. In an example, the computing system 120 may receive the second signature from the interconnecting network device 114b.

At block 206, the computing system 120 may perform a check to determine whether the second signature is different from the first signature. The computing system 120 may wait for a predetermined time period (described previously) after receiving the first signature for determining whether the second signature is different from the first signature. In some examples, the computing system 120 may compare the second signature with the first signature. At block 206, in response to a determination that the second signature is the same as the first signature, the computing system 120 may determine that the state of the cluster data at the interconnecting network device 114b may be the same as the first state of the cluster data at the leader gateway 112a. In these situations, the computing system 120 may determine that the interconnecting network device 114b is consistent with the leader gateway 112a. In such instances, no action is required as shown in block 208.

Referring to block 206 again, in response to a determination that the second signature is different from the first signature, the computing system 120 may determine that the state of the cluster data at the interconnecting network device 114b is different from the first state of the cluster data at the leader gateway 112a. In these instances, the computing system 120 may determine that the interconnecting network device 114b has not received the first state of the cluster data and is inconsistent with the leader gateway 112a.

Further, at block 210, the computing system 120 may send a message to a member gateway 111 mapped to the inconsistent interconnecting network device 114b to update the cluster data at the inconsistent interconnecting network device 114b to represent the first state. In response to receiving the message, the member gateway 111 may send the first state to the interconnecting network device 114b to update the interconnecting network device 114b to be consistent with the leader gateway 112a.

In some other examples, in response to a determination that a member gateway 111 (e.g., the member gateway 112b) is inconsistent with the leader gateway 112a, the computing system 120 may send another message to the leader gateway 112a to update the cluster data at the inconsistent member gateway 112b. In response to receiving the message, the leader gateway 112a may send the first state to the member gateway 112b to update the member gateway 112b to be consistent with the leader gateway 112a.

Turning to FIG. 3 now, a flow diagram depicting an example method 300 for maintaining consistent cluster data across the cluster 115 is presented, in accordance with another example. FIG. 3 includes certain method blocks that are similar to one or more method blocks described in FIG. 2, details of which are not repeated herein for the sake of brevity. By way of example, the blocks 302 and 308 of FIG. 3 are respectively similar to blocks 202 and 210 of FIG. 2. In an example, the method blocks 306-308 of the example method 300 of FIG. 3 may occur simultaneously or sequentially with the method blocks 202-210 of FIG. 2.

In particular, FIG. 3 depicts the example method 300 for automatically updating the cluster data on a new member network device (e.g., a member network device that has joined the network and belongs to the plurality of member devices 116). In these situations, it may be the first occurrence for the new member network device to receive the first state of the cluster data. In some situations where the new member network device receives the first state of the cluster data, the new member network device sends a signature (e.g., a third signature) of the first state of the cluster data to the computing system 120, and the computing system 120 may receive the third signature. In other situations where the new member network device does not receive the first state of the cluster data (e.g., due to dropping of a message), the computing system 120 may not receive the third signature.

At block 302, the computing system 120 may receive the first signature of the first state of the cluster data present at the leader gateway 112a of the cluster 115. At block 304, the computing system 120 may perform a check to determine whether the third signature is received from the new member network device. At block 304, in response to a determination that the third signature is received from the new member device (identified by its identification information), the computing system 120 may perform a check whether the third signature is the same as the first signature. In response to a determination that the third signature is the same as the first signature, the computing system 120 may determine that the new member network device has received the first state of the cluster data and is consistent with the leader gateway 112a. In these instances, no action may be required at block 306. Referring to block 304 again, in response to a determination that the third signature is not received from the new member network device, the computing system 120 may determine that the new member network device has not received the first state of the cluster data. In these instances, the computing system 120, at block 308, may send a message to one of the gateways 112 (e.g., the leader gateway 112a or a member gateway mapped to the new member network device) of the cluster 115 to update the cluster data at the new member network device to represent the first state. In response to receiving the message, the gateway may send the first state to the new member network device to update the new member network device to be consistent with the leader gateway 112a.

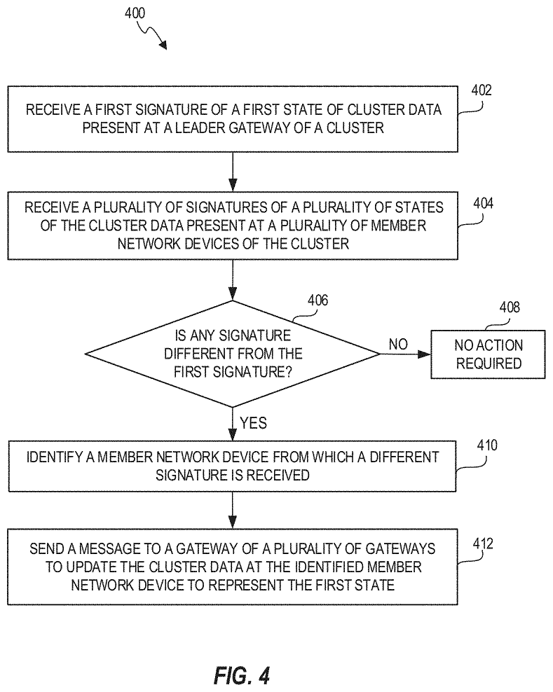

Moving to FIG. 4, a flow diagram depicting an example method 400 for maintaining consistent cluster data across the cluster 115, in accordance with another example. FIG. 4 includes certain method blocks that are similar to one or more method blocks described in FIG. 2, details of which are not repeated herein for the sake of brevity. By way of example, the blocks 402 and 412 of FIG. 4 are respectively similar to blocks 202 and 210 of FIG. 2.

At block 402, the computing system 120 may receive the first signature of the first state of the cluster data present at the leader gateway 112a of the cluster 115. Further, at block 404, the computing system 120 may receive a plurality of signatures of a plurality of states of the cluster data present at the member devices 116 of the cluster 115. Furthermore, at block 406, the computing system 120 may perform a check to determine whether any signature of the plurality of signatures is different from the first signature. In some examples, this includes comparing each signature of the plurality of signatures with the first signature. At 406, in response to a determination that none of the signatures is different from the first signature, the computing system 120 may determine that all the member devices 116 are consistent with the leader gateway 112a. In these examples, no action is required as per block 408. However, at block 406, in response to a determination that a signature is different from the first signature, the computing system 120 may, at block 410, identify a member device 116 (e.g., the interconnecting network device 114b) from which a different signature is received. In these instances, the computing system 120 may identify that the interconnecting network device 114b has not received the first state of the cluster data, and is an inconsistent member device. In some examples, the computing system 120 may identify more than one inconsistent member device 116 (e.g., interconnecting network device 114b and the member gateway 112b).

At block 412, the computing system 120 may send a message to a member gateway 111 mapped to the inconsistent interconnecting network device 114b to update the cluster data at the inconsistent interconnecting network device 114b.

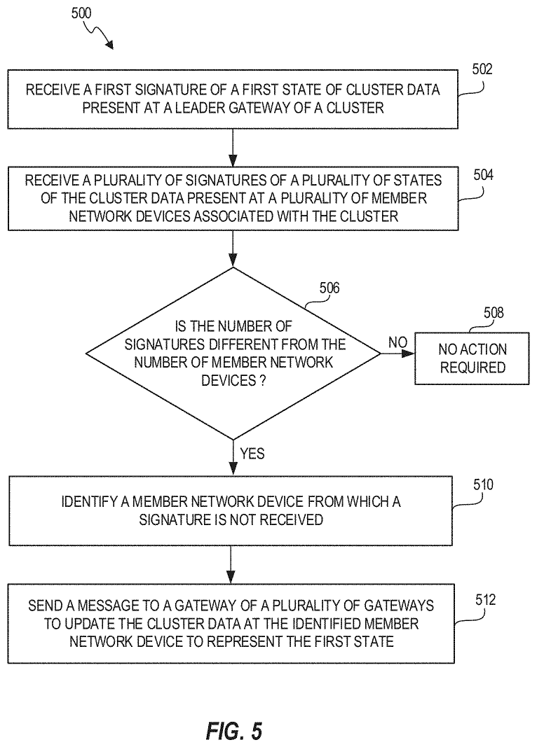

Moving to FIG. 5 now, a flow diagram depicting an example method 500 for maintaining consistent cluster data across the cluster 115, in accordance with another example. In particular, FIG. 5 depicts the example method 500 for automatically updating the cluster data on a network device of the plurality of network devices when it is the first occurrence for the network devices to receive the first state of the cluster data (e.g., when the network is deployed and the network devices are configured). FIG. 5 includes certain method blocks that are similar to one or more method blocks described in FIG. 4, details of which are not repeated herein for the sake of brevity. By way of example, the blocks 502, 504, and 512 of FIG. 5 are respectively similar to blocks 402, 404, and 412 of FIG. 4.

At block 502, the computing system 120 may receive the first signature of the first state of the cluster data present at the leader gateway 112a of the cluster 115. At block 504, the computing system 120 may receive a plurality of signatures of a plurality of states of the cluster data present at the member devices 116 of the cluster 115. At block 506, the computing system 120 may perform a check to determine whether a number of signatures received from the member devices 116 is different from a number of member devices of the member devices 116. At 506, in response to a determination that the number of signatures is not different from the number of member devices, the computing system 120 determines that all the member devices 116 are consistent with the leader gateway 112a. In these instances, no action is required as per block 508. Referring to block 506 again, in response to a determination that the number of signatures is different from the number of member devices, the computing system 120 may, at block 510, identify a member device 116 (e.g., the interconnecting network device 114b) from which a signature is not received. In response to determining that the signature is not received from the interconnecting network device 114b, the computing system 120 may identify that the interconnecting network device 114b is an inconsistent member device. At block 512, the computing system 120 may send a message to update the cluster data at the inconsistent interconnecting network device 114b to a member gateway 111 mapped to the inconsistent interconnecting network device 114b. In response to receiving the message, the member gateway 111 may send the first state to the inconsistent interconnecting network device 114b to update the interconnecting network device 114b to be consistent with the leader gateway 112a.

In some examples, the computing system 120 may perform a check to determine that a signature received from another member network device 116 (e.g., the member gateway 112n) is the same as the first signature. In some situations where the signature received from the member gateway 112n is different from the first signature, the computing system 120 may identify that the member gateway 112n is an inconsistent member device and then send a message to update the cluster data at the inconsistent member gateway 112n to the leader gateway 112a. In response to receiving the message, the leader gateway 112a may send the first state to the inconsistent member gateway 112n to update the member gateway 112n to be consistent with the leader gateway 112a

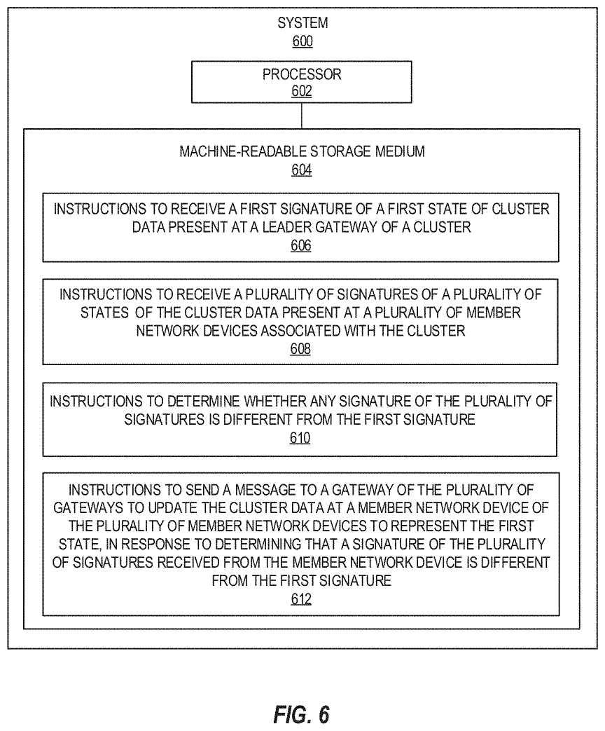

FIG. 6 is a block diagram of a system 600 for maintaining consistent cluster data across a cluster of a network (e.g., the network 110 of FIG. 1). As used herein, a “system” may include a server, a computing device, a network device (e.g., a network router), a virtualized device, a mobile phone, a tablet or any other processing device. A “system” may include software (machine-readable instructions), a dedicated hardware, or a combination thereof. In some examples, the system 600 may include a processor 602 and a machine-readable storage medium 604 communicatively coupled to the processor 602. The processor 602 may be any type of Central Processing Unit (CPU), microprocessor, or processing logic that interprets and executes machine-readable instructions stored in machine-readable storage medium 604.

Machine-readable storage medium 604 may be a random access memory (RAM) or another type of dynamic storage device that may store information and machine-readable instructions that may be executed by the processor 602. For example, the machine-readable storage medium 604 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, the machine-readable storage medium 604 may be a non-transitory machine-readable medium.

In an example, the machine-readable storage medium 604 may store machine-readable instructions (i.e. program code) 606, 608, 610, 612 (collectively ‘instructions 606-612’) that, when executed by the processor 602, may at least partially implement some or all functionalities described herein in relation to FIG. 6.

In some examples, the system 600 may be analogous to the processing resource of the computing system 120 of FIG. 1. In some examples, the system 600 may be remote from the computing system 120 and communicatively coupled to the computing system 120.

For ease of illustration, FIG. 6 is described with reference to FIG. 1. In certain examples, the instructions 606-612 may be executed for performing one or more method blocks of the example method 400 of FIG. 4. Although not shown, in some examples, the machine-readable storage medium 604 may be encoded with certain additional executable instructions to perform one or more method blocks of the example methods 200, 300, and 500 of FIGS. 2, 3, and 5, and/or any other operations performed by the computing system 120, without limiting the scope of the present disclosure. Further, it is contemplated that a computing device consistent with this disclosure could take many forms, including a cloud service, a network service, etc.

Instructions 606, when executed by the processor 602 may cause the processor 602, to receive a first signature of a first state of the cluster data at the leader gateway 112a of the cluster 115. Instructions 608, when executed by the processor 602 may cause the processor 602, to receive a plurality of signatures of a plurality of states of the cluster data present at the member devices 116. Instructions 610, when executed by the processor 602 may cause the processor 602, to determine whether any signature of the plurality of signatures is different from the first signature in response to receiving the first signature. In some examples, the instructions 610, when executed by the processor 602 may cause the processor 602, to identify an inconsistent member device 116 (e.g., the interconnecting network device 114b) from which a different signature is received. Further, instructions 612, when executed by the processor 602 may cause the processor 602, to send a message to a gateway of the plurality of gateways 112 to update the cluster data at the inconsistent member device 116 (e.g., the interconnecting network device 114b).

In the examples described herein, functionalities described as being performed by “instructions” may be understood as functionalities that may be performed by those instructions when executed by a processing resource. In other examples, functionalities described in relation to instructions may be implemented by one or more modules, which may be any combination of hardware and programming to implement the functionalities of the module(s).

The foregoing description of various examples has been presented for purposes of illustration and description. The foregoing description is not intended to be exhaustive or limited to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products except combinations where at least some of such features are mutually exclusive.

1. A method, comprising:
receiving, by a computing system, a first signature of a first state of cluster data present at a leader gateway of a cluster, wherein the cluster comprises a plurality of gateways including the leader gateway and a member gateway;
receiving, by the computing system, a second signature of a state of the cluster data present at a member network device of the cluster, wherein the member network device comprises the member gateway or an interconnecting network device associated with the cluster;
in response to receiving the first signature, determining, by the computing system, whether the second signature is different from the first signature, and whether a third signature of a state of the cluster data present at another member network device of the cluster is received;
in response to determining that the second signature is different from the first signature, sending, by the computing system, a message to a gateway of the plurality of gateways to update the cluster data at the member network device to represent the first state; and
in response to determining that the third signature is not received, sending, by the computing system, a message to the leader gateway or the member gateway to update the cluster data at the other member network device to represent the first state.

2. The method of claim 1, further comprising receiving, by the computing system, identification information of the leader gateway along with the first signature.

3. The method of claim 1, further comprising receiving, by the computing system, identification information of the member network device along with the second signature.

4. The method of claim 1, wherein the message comprises identification information of the member network device.

5. The method of claim 1, wherein the cluster data comprises a bucket map, a node list, or a combination thereof.

6. (canceled)

7. A computing system comprising a processor and a non-transitory machine-readable storage medium comprising instructions executable by the processor to:
receive a first signature of a first state of cluster data present at a leader gateway of a cluster in a network, wherein the cluster comprises a plurality of gateways including the leader gateway and a plurality of member gateways;
receive a plurality of signatures of a plurality of states of the cluster data present at a plurality of member network devices of the cluster, wherein the plurality of member network devices comprises the plurality of member gateways and a plurality of interconnecting network devices associated with the cluster;
in response to receiving the first signature, determine whether any signature of the plurality of signatures is different from the first signature, and whether a signature of a state of the cluster data is received from a new member network device, wherein the new member network device is associated to the cluster;
in response to determining that a signature of the plurality of signatures received from a member network device of the plurality of member network devices is different from the first signature, send a message to a gateway of the plurality of gateways to update the cluster data at the member network device to represent the first state; and
in response to determining that the signature is not received from the new member network device, send a message to the gateway or another gateway of the plurality of gateways to update the cluster data at the new member network device to represent the first state.

8. The computing system of claim 7, wherein the instructions further comprise instructions to receive identification information of the leader gateway along with the first signature.

9. The computing system of claim 7, wherein the instructions comprise instructions to receive identification information of the plurality of member network devices along with the plurality of signatures.

10. The computing system of claim 7, wherein the instructions to determine further comprise instructions to compare each signature of the plurality of signatures with the first signature.

11. The computing system of claim 7, wherein the message comprises identification information of the member network device.

12. The computing system of claim 7, wherein the cluster data comprises a bucket map, a node list, or a combination thereof.

13. (canceled)

14. The computing system of claim 7, wherein the instructions further comprise instructions executable by the processor to:
in response to receiving the first signature, determine whether a number of signatures of the plurality of signatures is different from a number of member network devices of the plurality of member network devices;
in response to determining that the number of signatures is different from the number of member network devices, identify another member network device of the plurality of member network devices from which a signature is not received; and
send a message to the gateway or another gateway of the plurality of gateways to update the cluster data on the other member network device to represent the first state.

15. A non-transitory machine-readable storage medium comprising instructions executable by a processor of a system to:
receive a first signature of a first state of cluster data present at a leader gateway of a cluster in a network, wherein the cluster comprises a plurality of gateways including the leader gateway and a plurality of member gateways;
receive a plurality of signatures of a plurality of states of the cluster data present at a plurality of member network devices of the cluster, wherein the plurality of member network devices comprises the plurality of member gateways and a plurality of interconnecting network devices associated with the cluster;
in response to receiving the first signature, determine whether any signature of the plurality of signatures is different from the first signature, and whether a signature of a state of the cluster data is received from a new member network device, wherein the new member network device is associated to the cluster;
in response to determining that a signature of the plurality of signatures received from a member network device of the plurality of member network devices is different from the first signature, send a message to a gateway of the plurality of gateways to update the cluster data at the member network device to represent the first state; and
in response to determining that the signature is not received from the new member network device, send a message to the gateway or another gateway of the plurality of gateways to update the cluster data at the new member network device to represent the first state.

16. The non-transitory machine-readable storage medium of claim 15, wherein the instructions further comprise instructions to receive identification information of the leader gateway along with the first signature.

17. The non-transitory machine-readable storage medium of claim 15, wherein the instructions comprise instructions to receive identification information of the plurality of member network devices along with the plurality of signatures.

18. The non-transitory machine-readable storage medium of claim 15, wherein the message comprises identification information of the member network device.

19. (canceled)

20. The non-transitory machine-readable storage medium of claim 15, wherein the instructions further comprise instructions executable by the processor to:
in response to receiving the first signature, determine whether a number of signatures of the plurality of signatures is different from a number of member network devices of the plurality of member network devices;
in response to determining that the number of signatures is different from the number of member network devices, identify another member network device of the plurality of member network devices from which a signature is not received; and
send a message to the gateway or another gateway of the plurality of gateways to update the cluster data on the other member network device to represent the first state.
